(19) United States
(12) Patent Application Publication
(10) Pub. No.: US 2022/0057979 A1
(43) Pub. Date: Feb. 24, 2022

(54) MODULAR ENTERTAINMENT POD

(71) Applicant: Dune Enterprises, Pasadena, CA (US)

(72) Inventors: Andrew Sean Wong, Pasadena, CA (US); Stephen Joseph Horvath, San Gabriel, CA (US); Maxwell Francis Horvath, San Gabriel, CA (US); Leonardo Pham, San Gabriel, CA (US); Nikolai Neira Garcia, San Gabriel, CA (US)

(73) Assignee: Dune Enterprises, Pasadena, CA (US)

(21) Appl. No.: 17/407,080

(22) Filed: Aug. 19, 2021

Related U.S. Application Data
(60) Provisional application No. 63/067,844, filed on Aug. 19, 2020.

(51) Int. Cl. G06F 3/14; G06F 3/147; G09G 3/00

(52) U.S. Cl. CPC G06F 3/1446; G06F 3/147; H04R 1/028; G09G 3/001; G09G 2300/026; G06F 3/1454

(57) ABSTRACT

An apparatus and methods for a modular entertainment pod are provided for preventing a transfer of airborne droplets and contagious aerosols within a large group of people. Multiple modular entertainment pods may be used to divide the large group of people into smaller groups. The modular entertainment pod provides audio and visual content to a small group of people. Screens supported around a perimeter of a supportive deck portion provide a surrounding display of visual content to the people within the pod. Speakers mounted above the screens provide a surrounding audio experience to the people within the pod. The multiple modular entertainment pods enable the small groups of people to socially distance themselves within the large group of people. The multiple modular entertainment pods may be synchronized to simultaneously present media content to all of the small groups of people.

### PRIORITY

This application claims the benefit of and priority to U.S. Provisional Application, entitled “Modular Entertainment Pod,” filed on Aug. 19, 2020 and having application Ser. No. 63/067,844, the entirety of said application being incorporated herein by reference.

### FIELD

Embodiments of the present disclosure generally relate to the field of medical safety devices. More specifically, embodiments of the disclosure relate to modular entertainment pods and methods for inhibiting the transfer of airborne droplets and contagious aerosols among attendees of large-group settings.

### BACKGROUND

Microbes, such as bacteria and viruses, can be transmitted through airborne droplets and aerosols, as well as transmitted by hand-to-hand or hand-to-surface contact. Transmission of microbes, particularly highly contagious microbes, is a serious health problem and is well known to lead to infections that can spread quickly. As will be appreciated, groups of people seated or working in proximity gives rise to an increased risk of spreading dangerous contagions.

Contagious diseases such as influenza, COVID-19, and the like are affecting many procedures used by the general public. Infection disease specialists acknowledge that aerosols from breathing and speaking can accumulate and remain infectious in indoor air for hours and can be easily inhaled into the lungs. In an attempt to combat the spread of diseases, many public venues such as retail stores, super markets, and banks are increasingly relying upon protective shields or barriers to block airborne droplets and thus inhibit aerosol virus transmission while allowing safe access to the public.

Venues involving large groups of attendees gathering close by one another, such as restaurants, churches, theaters, clubs, concerts, and the like are particularly susceptible to spreading airborne droplets and viral aerosols among the attendees. Many of such venues generally comprise relatively small indoor spaces, include tight seating, and may see upwards of a thousand people gathering on any given day. As such, audience-like settings place attendees at an increased risk of encountering a wide variety of dangerous contagions. Embodiments disclosed herein provide modular entertainment pods and methods for inhibiting the transfer of airborne droplets and contagious aerosols among attendees of large-group settings.

### SUMMARY

An apparatus and methods for a modular entertainment pod are provided for preventing airborne droplets and contagious aerosols from freely transferring among a large group of people. Multiple modular entertainment pods may be used to divide the large group of people into a plurality of small groups of people. The modular entertainment pod is configured to provide audio and visual content to the small group of people. The modular entertainment pod includes a deck portion for supporting the small group of people. One or more screens are supported around a perimeter of the deck portion and define an enclosed area. The screens are configured to provide a surrounding display of images, moving designs, or videos to the small group of people within the enclosed area. One or more speakers may be mounted above the one or more screens are configured to provide a surrounding audio experience to the small group of people within the enclosed area. The multiple modular entertainment pods are configured to enable the small groups of people to socially distance themselves within the large group of people. The multiple modular entertainment pods may be synchronized such that media content may be simultaneously presented to the multiple modular entertainment pods. In some embodiments, at least a portion of the multiple modular entertainment pods may be electronically interconnecting to enable small groups of people in separate modular entertainment pods to communicate with one another.

In an exemplary embodiment, a modular entertainment pod for providing audio and visual content to a small group of people comprises: a deck portion for supporting the small group of people; one or more screens supported around a perimeter of the deck portion and defining an enclosed area; one or more speakers mounted above the one or more screens; and an entrance for providing ingress into the enclosed area.

In another exemplary embodiment, the one or more screens are configured to protect the small group of people from airborne droplets and contagious aerosols outside the enclosed area. In another exemplary embodiment, the one or more screens are configured to enable the small group of people to socially distance themselves within a larger group of people. In another exemplary embodiment, the one or more screens are each supported by parallel vertical members and a horizontal support disposed between the tops of the parallel vertical members. In another exemplary embodiment, adjacent screens are joined such that the adjacent screens appear to be contiguous along the perimeter of the deck portion. In another exemplary embodiment, the one or more screens comprise a single sheet of screen material that is suspended around substantially an entirety of the perimeter of the deck portion. In another exemplary embodiment, the entrance includes a hinged screen that may be closed to surround the small group of people within the enclosed area.

In another exemplary embodiment, the deck portion comprises a hexagonal shaped member that includes at least six screens. In another exemplary embodiment, the deck portion is configured to operate as a floor that supports the weight of the small group of people within the modular entertainment pod. In another exemplary embodiment, the deck portion comprises a number of smaller components that may be assembled at a location where the modular entertainment pod is desired. In another exemplary embodiment, the deck portion is configured to house any electronic equipment that may be incorporated into the modular entertainment pod. In another exemplary embodiment, the deck portion houses AC wiring and includes multiple AC sockets that facilitate powering electronic equipment.

In another exemplary embodiment, the one or more screens are configured to provide a surrounding display of images, moving designs, or videos to the small group of people within the enclosed area. In another exemplary embodiment, the modular entertainment pod further comprises one or more projectors stationed outside the modular entertainment pod and configured to project visual content onto an outside of the one or more screens, such that the small group of people may observe the visual content. In another exemplary embodiment, the one or more speakers are configured to provide a surrounding sound experience to the small group of people within the enclosed area.

In an exemplary embodiment, a method of preventing airborne droplets and contagious aerosols from freely transferring among a large group of people comprises: providing a multiplicity of modular entertainment pods; electronically interconnecting the multiplicity of modular entertainment pods; dividing the large group of people into a plurality of smaller groups of people; populating the multiplicity of modular entertainment pods with the plurality of smaller groups of people; and synchronizing at least a portion of the multiplicity of modular entertainment pods such that media content may be simultaneously presented to the portion of the multiplicity of modular entertainment pods.

In another exemplary embodiment, providing includes assembling a deck portion for supporting a small group of people; supporting one or more screens around a perimeter of the deck portion to define an enclosed area; mounting one or more speakers above the one or more screens; and providing an entrance for ingress into the enclosed area. In another exemplary embodiment, dividing includes enabling the smaller groups of people to socially distance themselves within the large group of people. In another exemplary embodiment, electronically interconnecting includes configuring at least a portion of the multiplicity of modular entertainment pods to hail and communicate with one another.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a perspective view of an exemplary embodiment of a modular entertainment pod configured to provide audio and visual content to a small group of people in accordance with the present disclosure; and

FIG. 2 illustrates an interior view of an exemplary embodiment of a modular entertainment pod comprising screens configured to provide a surrounding display of visual content to a small group of people.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first screen,” may be made. However, the specific numeric reference should not be interpreted as a literal sequential order but rather interpreted that the “first screen” is different than a “second screen.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Contagious diseases such as influenza and COVID-19 are affecting many procedures used by the general public. Aerosols from simply breathing and speaking can accumulate and remain infectious in indoor air for hours and can be easily inhaled into the lungs. Venues involving large groups of attendees gathering close by one another, such as restaurants, churches, theaters, clubs, concerts, and the like are particularly susceptible to spreading airborne droplets and viral aerosols among the attendees. Many of such venues generally comprise relatively small indoor spaces, include tight seating, and may see upwards of a thousand people gathering on any given day. As such, audience-like settings place attendees at an increased risk of encountering a wide variety of dangerous contagions. Embodiments disclosed herein provide modular entertainment pods and methods for inhibiting the transfer of airborne droplets and contagious aerosols among attendees of large-group settings.

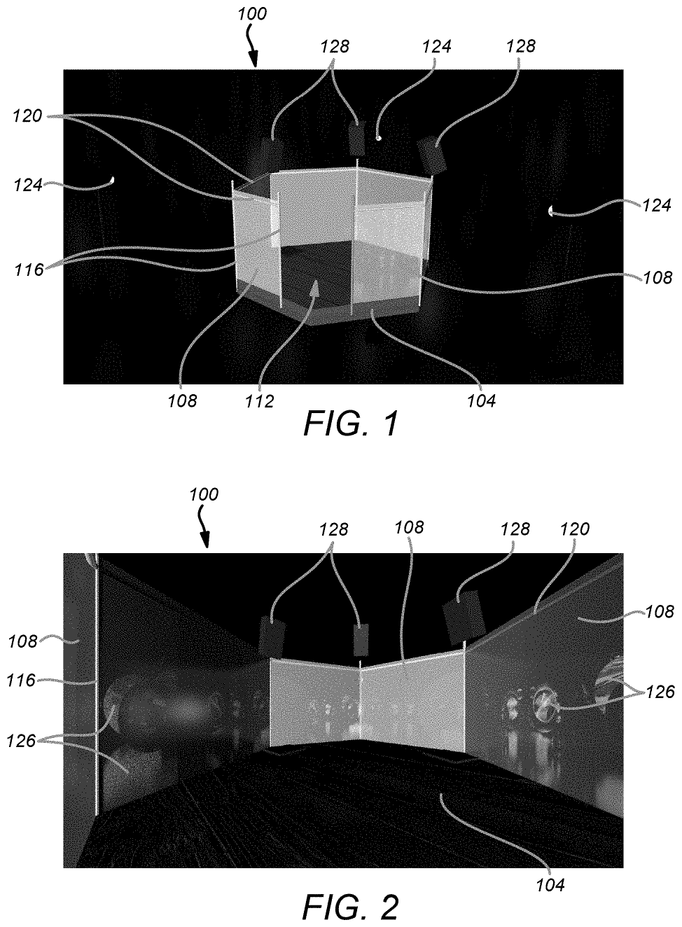

FIG. 1 illustrates a perspective view of a modular entertainment pod 100 configured to provide audio and visual content to a small group of people in accordance with the present disclosure. The modular entertainment pod 100 generally comprises a deck portion 104 and multiple screens 108 that may be erected around a perimeter of the deck portion 104. The multiple screens 108 generally define an enclosed area suitable for providing entertaining content to a relatively small group of people. An entrance 112 is configured to provide ingress into the enclosed area. In some embodiments, the entrance 112 may include a hinged screen, similar to the screens 108, that may be closed so as to surround the small group of people with the screens 108.

It is contemplated that the deck portion 104 may be implemented in any of various suitable shapes and sizes, as desired. In the illustrated embodiment, for example, the deck portion 104 comprises a hexagonal shaped member that includes six screens 108. In other embodiments, however, the deck portion 104 may comprise any of various polygonal shapes and may include any number of screens 108 as needed to extend around the perimeter of deck portion 104. In some embodiments, however, the deck portion 104 may comprise any of various sizes of circular or elliptical shapes, without limitation. Moreover, it is contemplated that the deck portion 104 may be configured to support any of various chairs, benches, and tables, as desired. For example, in one embodiment, bench seats may be mounted along the edges of the deck portion 104 adjacent to the screens 108.

In addition to supporting the screens 108, the deck portion 104 generally is configured to operate as a floor that supports the weight of the small group of people within the modular entertainment pod 100. In some embodiments, the deck portion 104 may comprise a number of smaller components that may be assembled at a location where the modular entertainment pod 100 is desired. Further, it is contemplated that the deck portion 104 may be configured to house any electronic equipment that may be incorporated into the modular entertainment pod 100. For example, in one embodiment, the deck portion 104 may house AC wiring and include multiple AC sockets that facilitate powering electronic equipment, such as, by way of non-limiting example, sound and lighting equipment that may be used by a DJ for entertaining the small group of people within the pod 100. Such equipment may include a bass shaker that is integrated into the deck portion 104, as well as comprising a central hub that includes audio and video controls such as volume and dimmer knobs, without limitation. Further, in some embodiments, the deck portion 104 may house wireless connectivity equipment that offers interactivity to the small group of people. For example, the deck portion 104 may include connectivity by way of Wi-Fi, Bluetooth, or another suitable protocol, without limitation.

In the illustrated embodiment of FIG. 1, the screens 108 are each supported by parallel vertical members 116 and a horizontal support 120 disposed between the tops of the parallel vertical members 116. As will be appreciated, the deck portion 104 is configured to support the vertical members 116, such as by way of holes, brackets, or any of various hardware fasteners. As shown in FIG. 2, adjacent screens 108 preferably are joined such that the screens 108 appear to be contiguous along the perimeter of the modular entertainment pod 100. In some embodiments, the screens 108 may comprise a single sheet of screen material that is suspended around substantially an entirety of the perimeter of the modular entertainment pod 100 by way of the vertical members 116 and the horizontal supports 120.

As best shown in FIG. 2, the screens 108 may be used to provide a surrounding display of visual content, such as images, moving designs, or videos to the small group of people within the modular entertainment pod 100. It is contemplated that the screens 108 may be made of any material suitable for receiving and/or projecting visual content 126. In one embodiment, multiple projectors 124 may be stationed outside the modular entertainment pod 100 and oriented to project visual content 126 onto an outside of the screens 108, such that the small group of people within the pod 100 may observe the visual content 126. Further, in some embodiments, a speaker 128 may be mounted atop each vertical member 116 and configured to provide a surrounding audio experience to the small group of people within the pod 100. It is contemplated that in a darkened environment, the members and supports 116, 120, and the speakers 128 will be advantageously obscured from view, thereby causing the modular entertainment pod 100 to provide an optimal theater experience to the small group of people.

It should be borne in mind that the speakers 128 may be coupled with the modular entertainment pod 100 in configurations other than atop the vertical members 116. For example, in some embodiments, the speakers 128 may be mounted to a midpoint of each vertical member 116. Further, in some embodiments, the speakers 128 may be mounted to suitable stands, such as tripods, that support the speakers nearby the modular entertainment pod 100. In some embodiments, multiple speakers having different sizes may be coupled with different locations of the modular entertainment pod 100. For instance, each vertical member 116 may support a bass speaker and a tweeter in addition to the speaker 128. Other speaker 128 configurations will be apparent to those skilled in the art.

The screens 108 generally operate as barriers configured to protect the small group of people within the modular entertainment pod 100 from airborne droplets and contagious aerosols that may be present outside the pod 100. As such, it is contemplated that a multiplicity of modular entertainment pods 100 may be implemented for the purpose of dividing an otherwise large group of attendees, such as an audience, into multiple smaller groups of attendees. For example, an outdoor music concert or theater that might draw many hundreds or more attendees may include a multiplicity of modular entertainment pods 100 that enable the attendees to divide into small, socially distanced groups. It is contemplated that the multiplicity of modular entertainment pods 100 advantageously prevents airborne droplets and contagious aerosols from freely transferring among the attendees.

In some embodiments, any number of the multiplicity of modular entertainment pods 100 may be electronically coupled together such that people in separate pods 100 may communicate with one another. For example, in some embodiments, a first small group of people in a first modular entertainment pod 100 may communicate and/or share information and media with a second small group of people in a second modular entertainment pod 100. As such, the first and second modular entertainment pods 100 may include integrated microphones and cameras that facilitate interactivity between the pods 100. Further, in some embodiments, the first and second groups may cause the first and second modular entertainment pods 100 to become synchronized such that the first and second groups may simultaneously view and listen to the same media content. In some embodiments, each modular entertainment pod 100 within a group of pods 100 may be configured to hail and communicate with any one or more of other modular entertainment pods 100 comprising the group. In some embodiments, all of the modular entertainment pods 100 may be synchronized such that the same media content is simultaneously presented to all of the pods 100.

In some embodiments, the modular entertainment pod 100 may be configured to enable interactivity to the people within the pod 100. For example, in some embodiments, a multiplicity of modular entertainment pods 100 may be interactively configured such that people within each pod 100 may communicate requests to a console or an application. For example, members of an audience that is divided into multiple modular entertainment pods 100 may interact with a suitable application for ordering food and beverages to be delivered to their pods 100. It is contemplated that the deck portion 104 may include equipment that enables wirelessly accessing the application by way of a personal computing device, such as a smart phone, tablet computer, PDA, and the like, and then view the application on one or more of the screens 108. Further, in some embodiments, the deck portion 104 includes wireless equipment and applications that facilitates broadcasting content and images from the personal computing device to the screens 108.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A modular entertainment pod for providing audio and visual content to a small group of people, comprising:
a deck portion for supporting the small group of people;
one or more screens supported around a perimeter of the deck portion and defining an enclosed area;
one or more speakers mounted above the one or more screens; and
an entrance for providing ingress into the enclosed area.

2. The modular entertainment pod of claim 1, wherein the one or more screens are configured to protect the small group of people from airborne droplets and contagious aerosols outside the enclosed area.

3. The modular entertainment pod of claim 1, wherein the one or more screens are configured to enable the small group of people to socially distance themselves within a larger group of people.

4. The modular entertainment pod of claim 1, wherein the one or more screens are each supported by parallel vertical members and a horizontal support disposed between the tops of the parallel vertical members.

5. The modular entertainment pod of claim 1, wherein adjacent screens are joined such that the adjacent screens appear to be contiguous along the perimeter of the deck portion.

6. The modular entertainment pod of claim 1, wherein the one or more screens comprise a single sheet of screen material that is suspended around substantially an entirety of the perimeter of the deck portion.

7. The modular entertainment pod of claim 1, wherein the entrance includes a hinged screen that may be closed to surround the small group of people within the enclosed area.

8. The modular entertainment pod of claim 1, wherein the deck portion comprises a hexagonal shaped member that includes at least six screens.

9. The modular entertainment pod of claim 1, wherein the deck portion is configured to operate as a floor that supports the weight of the small group of people within the modular entertainment pod.

10. The modular entertainment pod of claim 1, wherein the deck portion comprises a number of smaller components that may be assembled at a location where the modular entertainment pod is desired.

11. The modular entertainment pod of claim 1, wherein the deck portion is configured to house any electronic equipment that may be incorporated into the modular entertainment pod.

12. The modular entertainment pod of claim 11, wherein the deck portion houses AC wiring and includes multiple AC sockets that facilitate powering electronic equipment.

13. The modular entertainment pod of claim 1, wherein the one or more screens are configured to provide a surrounding display of images, moving designs, or videos to the small group of people within the enclosed area.

14. The modular entertainment pod of claim 1, further comprising one or more projectors stationed outside the modular entertainment pod and configured to project visual content onto an outside of the one or more screens, such that the small group of people may observe the visual content.

15. The modular entertainment pod of claim 1, wherein the one or more speakers are configured to provide a surrounding sound experience to the small group of people within the enclosed area.

16. A method of preventing airborne droplets and contagious aerosols from freely transferring among a large group of people, comprising:
providing a multiplicity of modular entertainment pods;
electronically interconnecting the multiplicity of modular entertainment pods;
dividing the large group of people into a plurality of smaller groups of people;
populating the multiplicity of modular entertainment pods with the plurality of smaller groups of people; and
synchronizing at least a portion of the multiplicity of modular entertainment pods such that media content may be simultaneously presented to the portion of the multiplicity of modular entertainment pods.

17. The method of claim 16, wherein providing includes assembling a deck portion for supporting a small group of people; supporting one or more screens around a perimeter of the deck portion to define an enclosed area; mounting one or more speakers above the one or more screens; and providing an entrance for ingress into the enclosed area.

18. The method of claim 16, wherein dividing includes enabling the smaller groups of people to socially distance themselves within the large group of people.

19. The method of claim 16, wherein electronically interconnecting includes configuring at least a portion of the multiplicity of modular entertainment pods to hail and communicate with one another.
